(19) United States
(12) Patent Application Publication
(10) Pub. No.: US 2003/0152787 A1
(43) Pub. Date: Aug. 14, 2003

(54) Electromagnetic wave shielding member and display using the same

(76) Inventors: Fumihiro Arakawa, Tokyo-to (JP); Hiroshi Kojima, Tokyo-to (JP); Eiji Ohishi, Tokyo-to (JP)

Correspondence Address: PARKHURST & WENDEL, L.L.P., 1421 PRINCE STREET, SUITE 210, ALEXANDRIA, VA, 22314-2805, US

(21) Appl. No.: 10/297,830

(22) PCT Filed: Apr. 12, 2002
(86) PCT No.: PCT/JP02/03683

(30) Foreign Application Priority Data
Apr. 17, 2001 (JP) 2001-117633

(51) Int. Cl. H01F 1/16

(52) U.S. Cl. 428/457; 428/544

(57) ABSTRACT

There is provided an electromagnetic wave shielding member comprising: a transparent film substrate; and a mesh formed of a thin metal film stacked on the surface of the transparent film substrate through an adhesive and/or a pressure-sensitive adhesive, the adhesive and/or the pressure-sensitive adhesive comprising an absorber which can absorb specific wavelengths, i.e., the wavelengths of visible light and/or near-infrared.

### FIELD OF THE INVENTION

The present invention relates to an electromagnetic wave shielding member using a mesh of a thin metal film and a display device using the same. More particularly, the present invention relates to an electromagnetic wave shielding member which can cut or absorb a near-infrared radiation (light) generated from the inside of displays and can absorb specific wavelengths of external light, i.e., the wavelengths of visible light and/or near-infrared radiation (light), to improve the contrast and can realize good visibility, and a display using the same.

### BACKGROUND ART

From the viewpoint of a harmful effect of electromagnetic waves on the human body, lowering the emission intensity of electromagnetic waves to values satisfying specifications has hitherto been required of electronic devices, which generate electromagnetic waves, for example, electronic tubes for displays, for example, plasma displays.

In plasma display panels (hereinafter referred to also as “PDPs”), since plasma discharge is utilized for light emission, unnecessary electromagnetic waves in the frequency band range of 30 to 130 MHz are leaked outside the plasma display panels. For this reason, minimizing the electromagnetic waves is required from the viewpoint of avoiding a harmful effect on peripheral equipment (for example, information processing devices).

To satisfy these demands, electromagnetic wave shields, wherein the outer periphery of electronic devices or the like, which generate electromagnetic waves, is covered with a suitable conductive member, are generally adopted for removing or attenuating electromagnetic waves emitted from electronic devices, which generate electromagnetic waves, to the outside of the devices.

In display panels such as PDPs, it is common practice to provide an electromagnetic wave shielding plate having good see-through properties in front of a display.

The fundamental structure per se of electromagnetic wave shielding plates is relatively simple, and examples of conventional electromagnetic wave shielding plates include: an electromagnetic wave shielding plate wherein a thin transparent conductive film, such as a thin indium-tin oxide film (ITO film), has been formed by vapor deposition on the surface of a transparent glass or plastic substrate, sputtering or the like; an electromagnetic wave shielding plate wherein, for example, a suitable metallic screen, such as a wire mesh, has been applied to the surface of a transparent glass or plastic substrate; and an electromagnetic wave shielding plate wherein a fine mesh formed of a thin metal film has been provided on the surface of a transparent glass or plastic substrate by forming a thin metal film on the whole surface of the substrate, for example, by electroless plating or vapor deposition and treating the thin metal film by photolithography or the like.

The electromagnetic wave shielding plate comprising an ITO film provided on a transparent substrate has excellent transparency and generally has a light transmittance of about 90%. Further, since an even film can be formed on the whole surface of the substrate, when the electromagnetic wave shielding plate is used in displays or the like, there is no fear of causing moire or the like attributable to the electromagnetic wave shielding plate.

In the electromagnetic wave shielding plate comprising an ITO film provided on a transparent substrate, a vapor deposition or sputtering apparatus is used for the formation of the ITO film. The production apparatus used is expensive, and, further, the productivity is generally poor. This often increases the price of the electromagnetic wave shielding plate per se.

In the electromagnetic wave shielding plate comprising an ITO film provided on a transparent substrate, the electrical conductivity is inferior by at least one order to that of the electromagnetic wave shielding plate provided with a mesh formed of a thin metal film. Therefore, the function of shielding the emitted electromagnetic wave is unsatisfactory, and this poses a problem that electromagnetic waves are leaked and, in some cases, the specifications cannot be satisfied.

In the electromagnetic wave shielding plate comprising an ITO film provided on a transparent substrate, increasing the thickness of the ITO film is considered effective for improving the electrical conductivity. In this case, however, in some cases, the transparency is significantly deteriorated, and the price of the product is increased.

The use of the electromagnetic wave shielding plate comprising a metallic screen applied onto the surface of a transparent glass or plastic substrate or the application of a suitable metallic screen, such as a wire mesh, directly onto the surface of a display is simple in production process and is low in cost. This, however, suffers from a serious drawback that, since the light transmittance of a metallic screen having an effective mesh size (100 to 200 mesh) is not more than 50%, the display is sometimes very dark.

In the case of the electromagnetic wave shielding plate comprising a mesh formed of a thin metal film provided on the surface of a transparent glass or plastic substrate, since the external form is shaped by etching according to photolithography, a fine, high open area ratio (high light transmittance) mesh can be prepared. Further, since the mesh is formed of a thin metal film, the electrical conductivity is much higher than that of the ITO film or the like. This offers an advantage that strong emitted electromagnetic waves can be shielded. This electromagnetic wave shielding plate provided with the mesh formed of a thin metal film, however, cannot absorb external light reflected from the display panel and consequently often causes deteriorated visibility and, in addition, often suffers from a problem that the production process is troublesome and complicate and the productivity is low resulting in high production cost.

Thus, the electromagnetic wave shielding plates have respective advantages and disadvantages, and, in use, a suitable electromagnetic wave shielding plate is selected according to applications.

Among the above electromagnetic wave shielding plates, the electromagnetic wave shielding plate comprising a mesh formed of a thin metal film provided on the surface of a transparent glass or plastic substrate has good electromagnetic wave shielding properties and light transmission properties and has recently become used for electromagnetic wave shielding purposes in such a manner that the electromagnetic wave shielding plate is placed in front of display panels such as PDPs.

In the conventional electromagnetic wave shielding plates and displays, however, a feature, which cuts off or absorbs near-infrared radiation (light) emitted from the inside of the display and can absorb specific wavelengths, i.e., the wavelengths of visible light emitted from the inside of the display or derived from external light for improving the contrast, is stacked by a separate step, for preventing malfunction of other equipment. Therefore, in some cases, disadvantageously, the process is troublesome, the productivity is poor, and the total thickness of the stacked films is large.

An electromagnetic wave shielding member comprising a mesh formed of a thin metal film provided on the surface of a transparent glass or plastic substrate is shown in FIG. 4. This electromagnetic wave shielding member will be briefly described.

FIG. 4(a) is a plan view showing an electromagnetic wave shielding member, FIG. 4(b) a cross-sectional view taken on line A1-A2 of FIG. 4(a), and FIG. 4(c) an enlarged view of a part of a mesh portion. In FIGS. 4(a) and 4(c), direction X and direction Y are indicated for the clarification of the positional relationship and mesh shape. The electromagnetic wave shielding member shown in FIGS. 4(a) to 4(c) is an electromagnetic wave shielding member for an electromagnetic wave shielding plate which, in use, is placed in front of displays such as PDPs. In this electromagnetic wave shielding member, a grounding frame portion and a mesh portion are provided on one side of a transparent substrate. The grounding frame portion 415 is formed of the same thin metal film as the mesh portion and is provided around the periphery of the mesh portion 410 so as to surround the screen region of the display in using the electromagnetic wave shielding plate in such a manner that the electromagnetic wave shielding plate is placed in front of a display. As shown in FIG. 4(c) (a partially enlarged view of the mesh portion 410), the mesh portion 410 comprises a group of a plurality of lines 470 provided parallel to each other at a predetermined pitch Px in direction Y and a group of a plurality of lines 450 provided parallel to each other at a predetermined pitch Py in direction X.

FIG. 5(a) shows an example of the case where an electromagnetic wave shielding plate 500 using the electromagnetic wave shielding member shown in FIG. 4 is used in such a state that the electromagnetic wave shielding plate 500 is placed in front of PDP, and FIG. 5(b) an enlarged cross-sectional view of an electromagnetic wave shielding region (corresponding to portion B0) shown in FIG. 5(a).

As shown in FIG. 5(b), the electromagnetic wave shielding region (corresponding to portion B0) in the electromagnetic wave shielding plate 500 comprises, provided on the viewer side of a transparent glass substrate 510, an NIR layer (a near-infrared absorption layer) 530, an electromagnetic wave shielding member 400 shown in FIG. 4, and a first AR layer (an antireflection layer) film 540 in that order as viewed from the transparent glass substrate and, on the PDP 570 side of the transparent glass substrate 510, a second AR layer (an antireflection layer) film 520. The position of the NIR layer (near-infrared absorption layer) and the position of the electromagnetic wave shielding member are not particularly limited to those shown in FIG. 5(b). Further, if necessary, a colored layer for color regulation may be provided.

### SUMMARY OF THE INVENTION

The present inventor has now found that an electromagnetic wave shielding member comprising a transparent substrate and a mesh formed of a thin metal film provided, on the transparent substrate, with the aid of an adhesive and/or a pressure-sensitive adhesive comprising an absorber which absorbs specific wavelengths, i.e., the wavelengths of visible light and/or near-infrared, has see-through properties and electromagnetic wave shielding properties and, in a construction of a minimized number of layers, can cut off or absorb near-infrared radiation (light) emitted from the inside of the display and can absorb specific wavelengths, i.e., the wavelengths of visible light emitted from the inside of the display or derived from external light, for preventing the malfunction of other equipment, or for improving the contrast of images or the like on the screen of the display and for imparting good visibility. The present invention has been made based on such finding.

Accordingly, an object of the present invention is to provide an electromagnetic wave shielding member which has see-through properties and electromagnetic wave shielding properties by virtue of the absorption of specific wavelengths, i.e., the wavelengths of visible light and/or near-infrared, can improve the contrast of displays, and, at the same time, can significantly reduce the necessary number of layers stacked and the necessary number of steps in the process.

According to a first aspect of the present invention, there is provided an electromagnetic wave shielding member comprising: a transparent film substrate; and a mesh formed of a thin metal film stacked on the surface of the transparent film substrate through an adhesive and/or a pressure-sensitive adhesive, said adhesive and/or said pressure-sensitive adhesive comprising an absorber which can absorb specific wavelengths, i.e., the wavelengths of visible light and/or near-infrared.

According to a second aspect of the present invention, there is provided an electromagnetic wave shielding member comprising: the electromagnetic wave shielding member according to the first aspect of the present invention; and a layer, for flattening the concave/convex face of the mesh, stacked on the mesh layer formed of the thin metal film, at least one of the adhesive and/or the pressure-sensitive adhesive and the flattening layer comprising an absorber which can absorb specific wavelengths, i.e., the wavelengths of visible light and/or near-infrared.

According to a third aspect of the present invention, there is provided an electromagnetic wave shielding member comprising: the electromagnetic wave shielding member according to the first or second aspect of the present invention; and a layer comprising an absorber, which can absorb specific wavelengths, i.e., the wavelengths of visible light and/or near-infrared, stacked on the surface of the transparent film substrate or the surface of the flattening layer.

### BRIEF DESCRIPTION OF THE DRAWINGS

Description

FIG. 1 is a production process flow diagram showing an embodiment of a production process of an electromagnetic wave shielding member according to the present invention;

FIG. 2 is a partially sectional view illustrating masking treatment, etching treatment, and laminating treatment for laminating a silicone separator (a silicone-treated, easily separable PET film);

FIG. 3(a) is a diagram showing a positional relationship between a laminate member and a mesh portion and a grounding frame portion of an electromagnetic wave shielding member to be formed, FIG. 3(b) a diagram showing a mesh portion and a grounding frame portion, and FIGS. 3(c) and 3(d) cross-sectional views showing the layer construction of an electromagnetic wave shielding member prepared;

FIG. 4 is an explanatory view of an electromagnetic wave shielding member;

FIG. 5 is an explanatory view of an embodiment of the use of an electromagnetic wave shielding plate;

FIG. 6 is a cross-sectional view showing two embodiments (FIGS. 6(a) and 6(b)) of the layer construction of a metal foil 120 shown in FIG. 2;

FIG. 7 is a cross-sectional view showing an embodiment of the layer construction of the electromagnetic wave shielding member according to the present invention;

FIG. 8 is a cross-sectional view showing another embodiment of the layer construction of the electromagnetic wave shielding member according to the present invention; and

FIG. 9 is a typical cross-sectional view showing an embodiment of a display onto which the electromagnetic wave shielding member according to the present invention has been laminated.

### DESCRIPTION OF REFERENCE CHARACTERS IN THE DRAWINGS

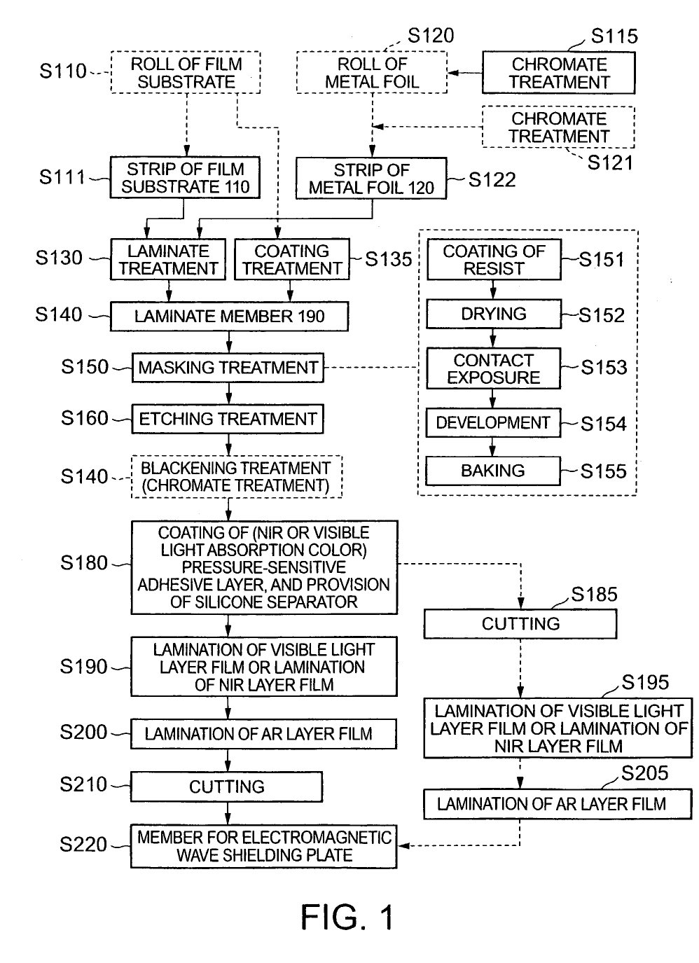

In FIGS. 1, 2, and 3, numeral 110 designates a film substrate, numeral 120 a metal foil, numeral 120A a mesh portion, numeral 120B a grounding frame portion, numeral 120C a treated portion, numeral 130 an adhesive layer, numeral 135 a pressure-sensitive adhesive layer, numeral 140 a silicone separator (a protective film), numeral 150 an NIR layer film, numeral 151 a film, numeral 152 an NIR layer, numeral 160 an AR layer film, numeral 161 a film, numeral 162 a hardcoat, numeral 163 an antireflection layer, numeral 164 an antifouling layer, numerals 170 and 175 each an adhesive layer, and numeral 190 a laminate member. In FIG. 1, S110 to S220 represent treatment steps.

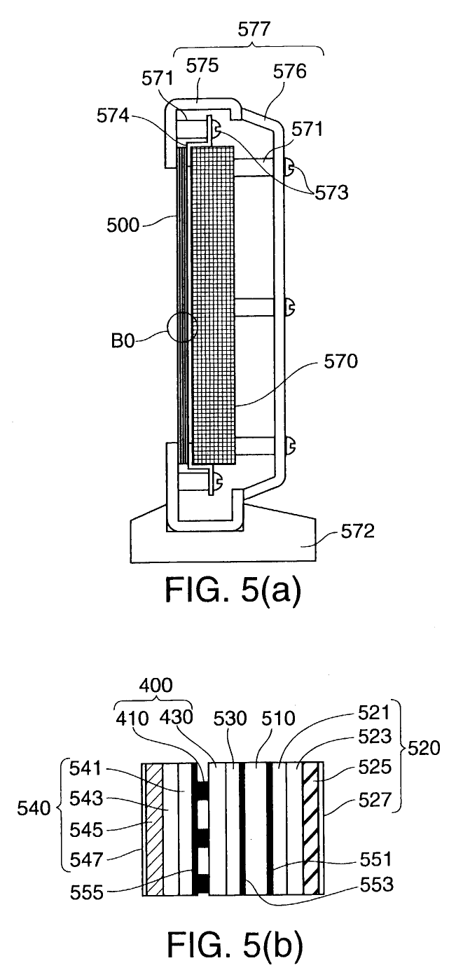

In FIG. 5, numeral 500 designates a front plate for display, numeral 400 an electromagnetic wave shielding member, numeral 410 a mesh portion, numeral 430 a transparent substrate, numeral 510 a glass substrate, numeral 520 a second AR layer film, numeral 521 a film, numeral 523 a hardcoat, numeral 525 an AR layer (an antireflection layer), numeral 527 an antifouling layer, numeral 530 an NIR layer (an near-infrared absorption layer), numeral 540 a first AR layer film, numeral 541 a film, numeral 543 a hardcoat, numeral 545 an AR layer (an antireflection layer), numeral 547 an antifouling layer, numerals 551, 553, and 555 each an adhesive layer, numeral 570 PDP (a plasma display), numeral 571 an attachment boss, numeral 573 a screw, numeral 572 a pedestal, numeral 574 a mounting bracket, numeral 575 the front part of a housing, numeral 576 the rear part of a housing, and numeral 577 a housing.

### DETAILED DESCRIPTION OF THE INVENTION

Embodiments of the Invention

The electromagnetic wave shielding member and the display according to the present invention will be described with reference to the accompanying drawings.

(1) An electromagnetic wave shielding member characterized by comprising: a transparent film substrate; and a mesh formed of a thin metal film stacked on one side of the transparent film substrate through an adhesive or a pressure-sensitive adhesive comprising an absorber which can absorb specific wavelengths, i.e., the wavelengths of visible light and/or near-infrared.

(2) An electromagnetic wave shielding member characterized by comprising: a transparent film substrate 4; a mesh 5 formed of a thin metal film stacked on one side of the transparent film substrate 4 through an adhesive or a pressure-sensitive adhesive; and a layer, for flattening the concave/convex face of the mesh 5 formed of the thin metal film, stacked on the mesh layer, at least one of the flattening layer 6, 13 and the adhesive or the pressure-sensitive adhesive comprising an absorber 8 which can absorb specific wavelengths, i.e., the wavelengths of visible light and/or near-infrared.

In this electromagnetic wave shielding member, the mesh 5 formed of a thin metal film may be stacked directly on one side of the transparent film substrate 4 without the aid of the adhesive or the pressure-sensitive adhesive (FIGS. 7 to 9).

(3) An electromagnetic wave shielding member characterized by comprising: a transparent film substrate 4; a mesh 5 formed of a thin metal film stacked on one side of the transparent film substrate 4 through an adhesive or a pressure-sensitive adhesive; a layer, for flattening the concave/convex face of the mesh 5 formed of the thin metal film, stacked on the mesh layer; and an adhesive or pressure-sensitive adhesive 3, 12, 14 stacked on at least one side of the flattening layer 6, 13 or the transparent film substrate 4, at least one of the flattening layer and the adhesive or the pressure-sensitive adhesive comprising an absorber 8 which can absorb specific wavelengths, i.e., the wavelengths of visible light and/or near-infrared (FIGS. 7 to 9).

In this electromagnetic wave shielding member, the mesh 5 formed of a thin metal film may be stacked directly on one side of the transparent film substrate 4 without the aid of the adhesive or the pressure-sensitive adhesive (FIGS. 7 to 9).

(4) The electromagnetic wave shielding member according to any one of the above items (1) to (3), characterized in that the thin metal film is a thin copper film.

(5) An electromagnetic wave shielding member comprising: the electromagnetic wave shielding member according to any one of the above items (1) to (4); and a visible light absorption layer and/or a near-infrared absorption layer stacked on the electromagnetic wave shielding member.

(6) An electromagnetic wave shielding member comprising: the electromagnetic wave shielding member according to any one of the above items (1) to (5); and an antireflection layer and/or an antiglare layer 1, 7 stacked on the electromagnetic wave shielding member (FIGS. 7 to 9).

(7) An electromagnetic wave shielding member comprising: the electromagnetic wave shielding member according to any one of the above items (1) to (6); and a transparent substrate 2 of glass or an acrylic resin stacked on the electromagnetic wave shielding member (FIGS. 7 to 9).

(8) A display device 30 comprising: a display; and the electromagnetic wave shielding member according to any one of the above items (1) to (7) stacked directly on the surface of the display (FIG. 9).

Electromagnetic Wave Shielding Member

(a) Transparent Film Substrate

The transparent film substrate is not particularly limited so far as the transparent film substrate is highly transparent, can withstand treatment, and is highly stable. However, PET films are preferred. In particular, biaxially stretched PET films are more preferred because the transparency, the chemical resistance, and the heat resistance are good.

When lamination, which will be described later, is carried out, examples of transparent film substrates, which require the use of an adhesive or a pressure-sensitive adhesive, include films of polyesters and polyethylene. On the other hand, examples of transparent film substrates, which do not require the use of any adhesive, include ethylene-vinyl acetate resin, ethylene-acrylic acid resin, ethylene-ethyl acrylate resin, and ionomer resin.

(b) Mesh Formed of Thin Metal Film

Thin Metal Film

In the electromagnetic wave shielding member according to the present invention, a mesh formed of a thin metal film is stacked on one surface of a transparent film substrate. Preferably, at least one surface of the mesh formed of a thin metal film has been blackened, for example, by chromate treatment, metal oxides, or metal sulfides. The blackened thin metal film has both electromagnetic wave shielding properties and see-through properties. In particular, when the surface of the thin metal film has been subjected to blackening treatment, particularly chromate treatment, for external light absorption purposes, a blackened layer can be provided which has high black density and high adhesion to the metal.

In the present invention, the black density of the chromated surface of the mesh formed of the thin metal film is preferably not less than 0.6. In this case, external light can be absorbed, and, thus, good visibility can be realized. Here all the measurements of black density in the present invention were carried out with GRETAG SPM 100-11 of COLOR CONTROL SYSTEM manufactured by KIMOTO under conditions of observation field of view=10 degrees and observation light source=D50. In this case, illumination type was set to density standard ANSI T, and each sample was measured after white calibration.

In the present invention, a metal foil is used in the thin metal film.

The surface roughness of the metal foil is preferably more than 0.5 μm and not more than 10 μm in terms of ten-point mean roughness Rz specified in JIS B 0601. When the surface roughness of the metal foil is not more than 0.5 μm in terms of ten-point mean roughness Rz specified in JIS B 0601, the external light is subjected to mirror reflection which deteriorates visibility, even in the case where the surface has been blackened. On the other hand, when the ten-point mean roughness Rz specified in JIS B 0601 is not less than 10 μm, in some cases, it is difficult to coat an adhesive, a resist or the like onto the metal foil.

The surface roughness of the (electrolytic) metal foil can be achieved by regulating the surface roughness of the metallic roll in the production of the material.

The metal constituting the metal foil is not particularly limited, and examples thereof include copper, iron, nickel, and chromium. Among them, copper is most preferred from the viewpoints of shielding properties of electromagnetic waves, suitability for etching, and handleability.

The copper foil may be a rolled copper foil or an electrolytic copper foil. The electrolytic copper foil is particularly preferred because a thickness of not more than 10 μm can be realized, the thickness is even, and the adhesion to the chromate film is good.

When the metal foil is an iron material (low-carbon steel or Ni—Fe alloy), an electromagnetic wave shielding member, which is particularly excellent in electromagnetic wave shielding properties, can be prepared.

The iron material is preferably substantially Ni-free low-carbon steel, such as low-carbon rimmed steel or low-carbon aluminum killed steel, from the viewpoint of etching treatment. However, the iron material is not limited to these steels only.

When the metal foil is thick, the formation of a high-definition pattern having a small line width is difficult due to side etching. on the other hand, when the metal foil is thin, satisfactory electromagnetic wave shielding effect cannot be attained. For this reason, the thickness of the metal foil is preferably 1 to 100 μm, particularly preferably 5 to 20 μm.

Chromate Treatment

In the present invention, chromate treatment is preferred for blackening the surface of the mesh formed of a thin metal film.

The chromate treatment refers to coating of a chromating liquid onto a material to be treated. The chromating liquid may be coated onto the thin metal film as the material to be treated, for example, by roll coating, air curtain coating, electrostatic spray coating, squeeze roll coating, or dip coating. In this case, the coating is dried without washing with water.

In the present invention, the material to be treated is a mesh formed of the above-described thin metal film.

An aqueous solution containing 3 g/liter of CrO₂ is generally used as the chromating liquid. “A chromating liquid prepared by adding, to an aqueous chromic anhydride solution, a different oxycarboxylic acid compound to reduce a part of chromium(VI) to chromium(III)” may also be used.

More preferably, not only the viewer side but also the display side is chromated because the stray of light from the display can be prevented.

In the present invention, specific examples of chromate treatment methods include a method wherein one side or the whole of the metal foil is dipped in an aqueous solution (25° C.) containing 3 g/liter of CrO₂ for 3 sec, and a method which comprises the steps of: adding, to an aqueous chromic anhydride solution, a different oxycarboxylic acid compound to reduce a part of chromium(VI) to chromium(III); roll coating the resultant chromating liquid onto a metal foil; and drying the coating at 120° C.

Oxycarboxylic acid compounds include tartaric acid, malonic acid, citric acid, lactic acid, glucolic acid, glyceric acid, tropic acid, benzilic acid, and hydroxyvaleric acid. These reducing agents may be used alone or in a combination of two or more. The reduction capability varies depending upon compounds. Therefore, the amount of the reducing agent added is determined by grasping a reduction to chromium(III).

(c) Visible Light Absorber and/or Absorber which Can Absorb Specific Wavelengths, i.e., Wavelengths of Near-Infrared

Visible Light Absorber

Visible light absorbers include metals and pigments. Metals as the visible light absorber include, for example, Nd (neodymium), Au (gold), Pt (platinum), Pd (palladium), Ni (nickel), Cr (chromium), Al (aluminum), Ag (silver), In₂O₃—SnO₂, CuI, CuS, and Cu (copper). They may be used solely or in a combination of two or more. Conventional pigments may be mentioned as the pigment used as the visible light absorber. Specific examples of such pigments include phthalocyanine, azo, condensed azo, azolake, anthraquinone, perylene or perinone, indigo or thioindigo, isoindolino, azomethineazo, dioxyzane, quinacridone, aniline black, triphenylmethane, or other organic pigments, and carbon black, neodymium compound, titanium oxide, iron oxide, iron hydroxide, chromium oxide, spinel-type sinter, chromic acid, chrome vermilion, iron blue, aluminum powder, bronze powder or other pigments.

Near-Infrared Absorber

Near-infrared generally refers to a region of 780 nm to 1000 nm, and the absorption in this wavelength region is preferably not less than 80%.

Absorbers (absorbing agents) capable of absorbing specific wavelengths, i.e., the wavelengths of near-infrared include: inorganic near-infrared absorbers, such as tin oxide, indium oxide, magnesium oxide, titanium oxide, chromium oxide, zirconium oxide, nickel oxide, aluminum oxide, zinc oxide, iron oxide, antimony oxide, lead oxide, and bismuth oxide; and organic near-infrared absorbers, such as cyanine compounds, phthalocyanine compounds, naphthalocyanine compounds, naphthoquinone compounds, anthraquinone compounds, diimoniums, nickel complexes, and dithiol complexes.

The inorganic near-infrared absorber is preferably in the form of fine particles which preferably have an average particle diameter in the range of 0.005 to 1 μm, particularly preferably in the range of 0.01 to 0.5 μm. In order to improve visible light transmittance, preferably, the fine particles of the inorganic near-infrared absorber have a particle size distribution such that the diameter of the fine particles is not more than 1 μm. Preferably, the near-infrared absorber is dispersed on a high dispersion level.

(d) Adhesive or Pressure-Sensitive Adhesive

The adhesive is not particularly limited, and specific examples thereof include adhesives of acrylic resin, polyester resin, polyurethane resin, polyvinyl alcohol or partially saponified product of polyvinyl alcohol (tradename: Poval), vinyl chloride-vinyl acetate copolymer, and ethylene-vinyl acetate copolymer. Heat-curable resins and ultraviolet-curable resins are preferred from the viewpoints of no significant dyeing with and deterioration by the etching solution, post treatment, lamination, coatability and the like. According to a preferred embodiment of the present invention, polyester resins are preferred from the viewpoints of adhesion to transparent polymeric substrates, compatibility with and dispersion in the visible light absorbers and near-infrared absorbers and the like.

The adhesive layer may be coated to a thickness of 1 to 100 μm onto a film substrate by various coating methods such as roll coating, Mayer bar coating, or gravure coating.

Pressure-sensitive adhesives include, for example, natural rubber, synthetic rubber, acrylic resin, polyvinyl ether, urethane resin, and silicone resin pressure-sensitive adhesives.

Specific examples of synthetic rubber pressure-sensitive adhesives include styrene-butadiene rubber (SBR), acrylonitrile-butadiene rubber (NBR), polyisobutylene rubber, isobutylene-isoprene rubber, isoprene rubber, styrene-isoprene block copolymer, styrene-butadiene block copolymer, and styene-ethylene-butylene block copolymer. Specific examples of silicone resin pressure-sensitive adhesives include dimethylpolysiloxane. These pressure-sensitive adhesives may be used alone or in a combination of two or more.

Further, if necessary, tackifiers, fillers, softeners, antioxidants, ultraviolet absorbers, crosslinking agents and the like may be mixed and dispersed in the pressure-sensitive adhesive.

The pressure-sensitive adhesive layer may be formed by coating to a thickness of 1 to 100 μm, preferably 10 to 50 μm, onto a film substrate by various coating methods such as roll coating, Mayer bar coating, or gravure coating.

According to a preferred embodiment of the present invention, in order to impart the capability of absorbing visible light and/or near-infrared to the adhesive and/or the pressure-sensitive adhesive, an absorber (a visible light absorber or a near-infrared absorber), which can absorb specific wavelengths, i.e., the wavelengths of visible light and/or near-infrared, is mixed and dispersed in the adhesive and/or the pressure-sensitive adhesive.

(e) Flattening Layer

In a preferred embodiment of the present invention, the electromagnetic wave shielding member further comprises a layer, for flattening the concave/convex face of the mesh formed of the thin metal film, stacked on the mesh layer.

The flattening layer may be formed of a resin. The resin should be highly transparent and should have good adhesion to the mesh formed of the thin metal film and the adhesive or the pressure-sensitive adhesive. The flattening layer is preferably formed using acrylic ultraviolet-curable resins from the viewpoints of coatability, hardcoat properties, easiness in flattening and the like.

According to a preferred embodiment of the present invention, the flattening layer contains an absorber which can absorb specific wavelengths, i.e., the wavelengths of visible light and/or near-infrared. When the flattening layer contains the absorber, the resin is preferably such that the dispersibility of the absorber in the resin is excellent.

If possible, the surface of the flattening layer is preferably free from protrusions, dents, lack of uniformity and the like. This is important particularly from the viewpoint of preventing moire and uneven interference in displays.

For example, a flattening layer having a high level of flatness can be formed by coating or applying a resin, laminating a substrate or the like having a high level of flatness onto the coating, then exposing the coating to heat or light to cure the resin, and separating the substrate. Imparting pressure-sensitive adhesive properties or adhesive properties to the flattening layer can realize the formation of a pressure-sensitive adhesive layer or an adhesive layer having a high level of flatness which can reduce the necessary number of layers or the necessary number of production steps.

(f) Visible Light Absorption Layer and Near-Infrared Absorption Layer

In the electromagnetic wave shielding member according to the present invention, a visible light absorption layer and a near-infrared absorption layer may be further stacked.

Visible Light Absorption Layer

The visible light absorption layer can advantageously absorb wavelengths in the visible light region (380 to 780 nm), can provide a color balance of displays, can absorb external light, and can improve contrast. The light transmittance of the visible light absorption layer is preferably in the range of 50 to 98%.

The above-described visible light absorber may be used in the visible light absorption layer. The visible light absorption layer may be formed by mixing and dispersing the visible light absorber in the adhesive and/or pressure-sensitive adhesive, the resin or the like and forming a layer using the dispersion. Alternatively, the visible light absorption layer may be formed, for example, by vapor deposition, CVD, or sputtering of the visible light absorber.

Near-Infrared Absorption Layer (NIR Layer)

Although the NIR layer (near-infrared absorption layer) is not particularly limited, the NIR layer preferably has steep absorption in the near-infrared region, has high light transmittance in the visible region, and does not have any large absorption of specific wavelengths, i.e., wavelengths in the visible region.

Near-infrared generally refers to a region of 780 nm to 1000 nm, and the absorption in this wavelength region is preferably not less than 80%.

The above-described near-infrared absorber may be used in the NIR layer. The NIR layer may be formed by mixing and dispersing the near-infrared absorber in the adhesive and/or pressure-sensitive adhesive, the resin or the like and forming a layer using the dispersion.

According to a preferred embodiment of the present invention, for example, a layer comprising at least one coloring matter, having a maximum absorption wavelength between light wavelength 800 nm and light wavelength 1000 nm, dissolved in a binder resin is used as the NIR layer, and the thickness of the NIR layer is about 1 to 50 μm.

Examples of the coloring matter include cyanine compounds, phthalocyanine compounds, naphthalocyanine compounds, naphthoquinone compounds, anthraquinone compounds, and dithiol complexes.

Binder resins include polyester resins, polyurethane resins, and acrylic resins. Crosslinked and cured binders using a reaction of epoxy, acrylate, methacrylate, isocyanate group or the like by ultraviolet irradiation or by heating may also be used.

Solvents usable for coating include cyclic ethers or ketones capable of dissolving the above coloring matter, for example, tetrahydrofuran, dioxane, cyclohexane, and cyclopentanone.

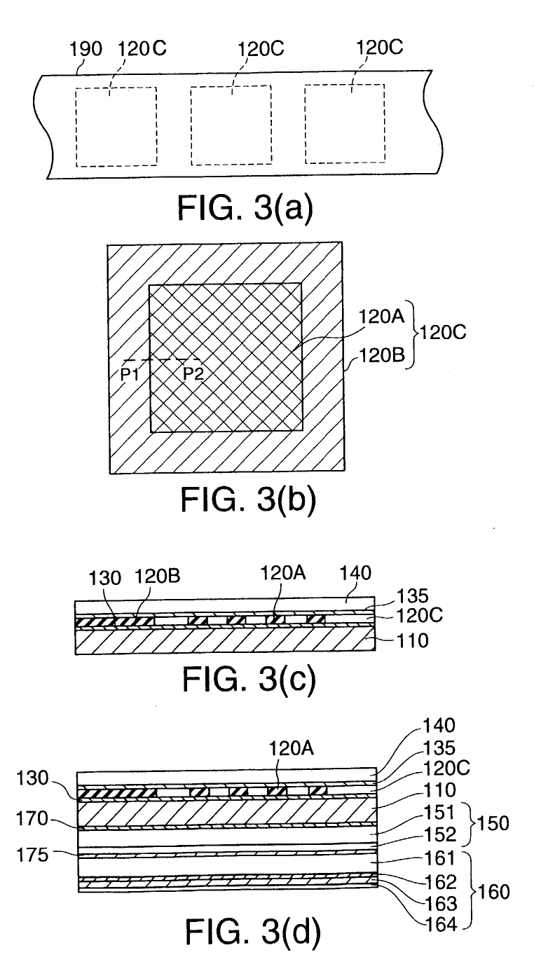

In the present invention, an NIR layer film (150 in FIG. 3(d)) may be used. The NIR layer film is a film wherein an NIR layer has been provided on a transparent film. For example, No. 2832 manufactured by Toyobo Co., Ltd., comprising an NIR layer coated onto a polyethylene terephthalate (PET) film, is a generally known commercially available NIR layer film.

(g) Antireflection Layer and Antiglare Layer

In the electromagnetic wave shielding member according to the present invention, an antireflection layer and an antiglare layer may be further stacked.

Antireflection Layer (AR Layer)

The antireflection layer functions to prevent the reflection of visible light. Various antireflection layers having a single-layer or multilayer structure are known. Antireflection layers having a multilayer structure are generally such that high-refractive index layers and low-refractive index layers are alternately stacked. The material for the antireflection (AR) layer is not particularly limited. The antireflection layer may be formed by a general method, for example, a dry method, such as sputtering or vapor deposition, or by wet coating.

The high-refractive index layer is formed of niobium oxide, titanium oxide, zirconium oxide, ITO or the like. The low-refractive index layer is generally formed of silicon oxide.

The hardcoat in the AR layer film may be formed by heat-curing or ionizing radiation-curing a polyfunctional acrylate, for example, a polyester acrylate, such as DPHA, TMPTA, or PETA, urethane acrylate, or epoxy acrylate. Here “having hard properties” or “hardcoat” refers to a hardness of H or more as measured by a pencil hardness test specified in JIS K 5400.

The antifouling layer stacked onto the AR layer is a water-repellent, oil-repellent coating, and examples thereof include siloxane antifouling coatings and fluoro antifouling coatings such as fluorinated alkylsilyl compound antifouling coatings.

Antiglare Layer

In the present invention, an antiglare layer commonly used in displays may be used.

(h) Transparent Substrate

In the electromagnetic wave shielding member according to the present invention, a transparent substrate may be further stacked.

Glass, polyacrylic resin, and polycarbonate resin substrates are suitable as the transparent substrate. If necessary, other plastic films may be used.

Plastic films usable herein include triacetylcellulose films, diacetylcellulose films, acetate butyrate cellulose films, polyether sulfone films, polyacrylic resin films, polyurethane resin films, polyester films, polycarbonate films, polysulfone films, polyether films, trimethylpentene films, polyether ketone films, and (meth)acrylonitrile films. Biaxially stretched polyesters are particularly preferred because of their excellent transparency and durability. In general, the thickness thereof is preferably about 8 to 1000 μm.

For large displays, a 1 to 10 mm-thick rigid substrate is used. On the other hand, for small displays for a character display tube, a 0.01 to 0.5 mm-thick plastic film having suitable flexibility is applied to the display.

The light transmittance of the transparent substrate is ideally 100%. The selection of a transparent substrate having a light transmittance of not less than 80% is preferred.

Display

According to the present invention, there is provided a display device comprising the above electromagnetic wave shielding member stacked on a display.

Production Process of Electromagnetic Wave Shielding Member

The electromagnetic wave shielding member according to the present invention is produced by the following production process. In the present invention, the mesh formed of a thin metal film may have not been necessarily blackened by chromate treatment. However, the use of a mesh formed of a thin metal film, at least one side of which has been blackened by chromate treatment, ispreferred. Accordingly, the production process will be described mainly with respect to the case where at least one side of which has been blackened by chromate treatment.

According to the present invention, there is provided a process for producing an electromagnetic wave shielding member, which, in use, is placed in front of a display, or alternatively may be applied directly to the display, said electromagnetic wave shielding member having electromagnetic wave shielding properties and see-through properties and comprising a transparent film substrate and a mesh formed of a thin metal film optionally at least one side of which has been blackened by chromate treatment or the like, said mesh being stacked on one side of the transparent film substrate through an adhesive or a pressure-sensitive adhesive comprising an absorber capable of absorbing specific wavelengths, i.e., the wavelengths of visible light and/or near-infrared, said process comprising the steps of:

(a) a laminate member formation treatment wherein a continuous metal foil strip and a continuous film substrate strip are laminated on top of each other to form a continuous laminate member strip and, while carrying the laminate member in a continuous or intermittent manner, successively performing;

(b) masking treatment wherein an etching-resistant resist mask, for etching the metal foil in the laminate member to form a mesh or the like, is formed in a continuous or intermittent manner along the longitudinal direction of the metal foil so as to cover the metal foil on its surface remote from the film substrate; and

(c) etching treatment wherein the metal foil in its portions exposed from openings of the resist mask is etched to form a mesh or the like formed of a thin metal film.

In this production process, before the lamination, both sides or one side of a copper foil or a metal foil formed of an iron material are blackened by chromate treatment. When both sides or one side of the copper foil or the metal foil formed of an iron material are not previously blackened by chromate treatment, after the etching treatment, the resist pattern is separated and removed and, if necessary, washing treatment is carried out, followed by blackening of the exposed surface of the mesh formed of the thin metal film by chromate treatment or the like.

After the etching treatment, if necessary, lamination treatment is carried out wherein an adhesive layer or a pressure-sensitive adhesive layer containing an absorber capable of absorbing specific wavelengths, i.e., the wavelengths of visible light and/or near-infrared is provided on the surface of the mesh formed of the thin metal film, and a silicone separator (a silicone-treated, easily separable PET film) is laminated thereon.

(a) Laminate Member Formation Treatment

The laminate member formation treatment is lamination treatment wherein a continuous metal foil strip is laminated onto the surface of a continuous film substrate strip to form a laminate member in the form of a continuous strip of a laminate of a metal foil and a film substrate.

Polyester, polyethylene and the like may be mentioned as the film substrate 110 which requires the use of an adhesive or the like in the lamination treatment. On the other hand, ethylene-vinyl acetate resin, ethylene-acrylic acid resin, ethylene-ethyl acrylate resin, and ionomer resin may be mentioned as the film substrate 110 which does not require the use of an adhesive in the lamination treatment.

The lamination member formation treatment may be carried out by coating a resin onto one side of a continuous metal foil strip by a coating method such as extrusion coating or hot melt coating.

Resins usable in the extrusion coating include polyolefins and polyesters. Resins usable in the hot melt coating include resins composed mainly of ethylene-vinyl acetate resin, resins composed mainly of polyesters, and resins composed mainly of polyamides.

(b) Etching Treatment

The etching treatment is characterized in that a ferric chloride solution is used as an etching solution. When the etching treatment of the metal foil is carried out using a ferric chloride solution as an etching solution, the etching solution can be easily circulated and reutilized and this can easily realize continuous etching treatment in a continuous through line. When the iron material is an Ni—Fe (nickel-iron) alloy such as an Invarmaterial (42% Ni—Fe alloy), the etching solution is contaminated with nickel. Therefore, to cope with this, the etching solution should be properly controlled.

(c) Masking Treatment

The masking treatment is characterized by comprising the steps of: coating a resist onto the surface of a metal foil; drying the coating; then subjecting the resist to contact exposure using a predetermined pattern plate; performing development treatment to form a predetermined resist pattern on the surface of the metal foil; and optionally baking the resist pattern.

(d) Others

In the production process according to the present invention, a method may be used wherein a feature not imparted to the pressure-sensitive color layer is stacked on a separate film and this laminate is then stacked. For example, the production process may be characterized by comprising the step of lamination wherein, after the lamination treatment wherein a silicone separator (a silicone-treated, easily separable PET film) is laminated, an NIR layer film comprising an NIR layer provided on one side of a film and an AR layer film comprising an AR layer provided on one side of a film are laminated in that order onto the surface of the transparent film substrate remote from the mesh. The lamination step is characterized by comprising the steps of: laminating the NIR layer film through an adhesive layer onto the surface of the transparent film substrate remote from the mesh; and then further laminating the AR layer film through an adhesive layer onto the NIR layer film, at least one of the adhesive and the pressure-sensitive adhesive containing an absorber which can absorb specific wavelengths, i.e., the wavelengths of visible light and/or near-infrared.

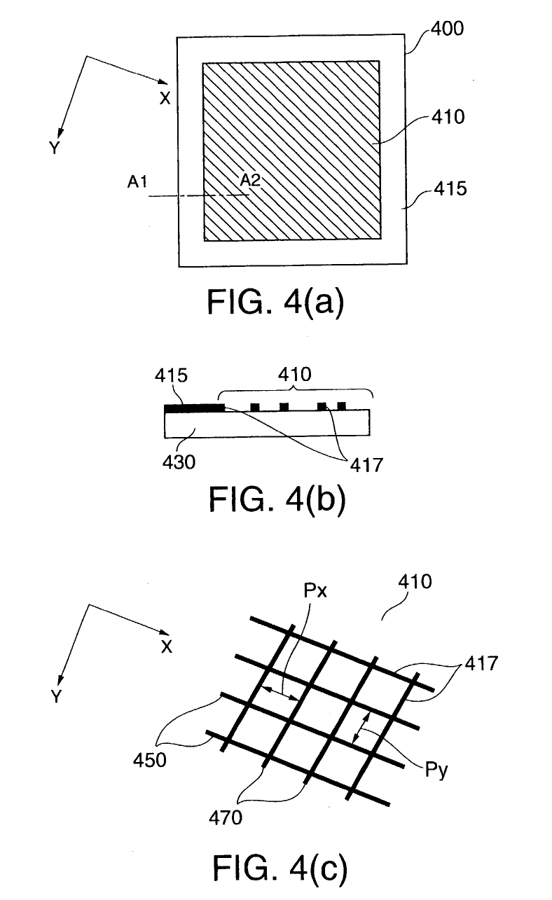

The production process according to the present invention can provide an electromagnetic wave shielding member which is excellent in quality and productivity. Therefore, the production process according to the present invention can realize the mass production of an electromagnetic wave shielding plate, for displays, such as, PDP, as shown in FIG. 4 or the like, having a capability of absorbing specific wavelengths, i.e., the wavelengths of visible light and/or near-infrared, and good visibility, see-through properties, and electromagnetic wave shielding properties, in a high productivity rate.

In another preferred embodiment of the present invention, there is provided a production process comprising the steps of:

(a′) a laminate member formation treatment wherein a continuous chromated metal foil strip and a continuous film substrate strip are laminated on top of each other to form a continuous laminate member strip and, while carrying the laminate member in a continuous or intermittent manner, successively performing;

(b′) masking treatment wherein an etching-resistant resist mask, for etching the metal foil in the laminate member to form a mesh or the like, is formed in a continuous or intermittent manner along the longitudinal direction of the metal foil so as to cover the metal foil on its surface remote from the film substrate; and

(c′) etching treatment wherein the metal foil in its portions exposed from openings of the resist mask is etched to form a mesh or the like formed of a thin metal film, wherein

(d′) after the etching treatment, a pressure-sensitive adhesive layer or a flattening layer containing an absorber capable of absorbing specific wavelengths, i.e., the wavelengths of visible light and/or near-infrared, is optionally provided on the surface of the mesh formed of a thin metal film, and

(e′) a silicone separator (a silicone-treated, easily separable PET film) is laminated.

According to this production process, as with the preparation of a shadow mask, for a cathode-ray tube for color TV, from a continuous strip of a steel product, masking treatment and etching treatment can be carried out in a continuous through line.

(a′) Chromate Treatment

In the present invention, when both sides or one side of a metal foil formed of a copper foil, an iron material or the like are blackened by chromate treatment before the laminate member formation treatment, reflection from the blackened surface of the metal foil can be prevented. In particular, when both sides or one side of the metal foil are blackened by chromate treatment before the laminate member formation treatment, the necessity of blackening treatment by the chromate treatment in a later stage can be eliminated and this can improve the work efficiency.

When both sides or one side of the metal foil formed of a copper foil or an iron material are not previously blackened, after the etching treatment, the resist pattern is separated and removed and, if necessary, washing treatment is carried out, followed by blackening of the exposed surface of the mesh formed of the thin metal film by chromate treatment. In this case, however, the work efficiency is deteriorated.

(b′) Laminate Member Formation Treatment

When the laminate member formation treatment is lamination treatment wherein a continuous metal foil strip is laminated onto the surface of a continuous film substrate strip to form a laminate member in the form of a continuous strip of a laminate of a metal foil and a film substrate, simple operation can be realized and, in addition, the metal foil can be continuously etched with good productivity.

(c′) Masking Treatment

When the masking treatment comprises coating a resist onto the surface of a metal foil, drying the coating, then subjecting the resist to contact exposure using a predetermined pattern plate, performing development treatment to form a predetermined resist pattern on the surface of the metal foil, and optionally baking the resist pattern, high-definition plate preparation using a resist can be realized and, in addition, a quality demand and a demand for mass production can be met.

(f′) Others

Formation of Flattening Layer

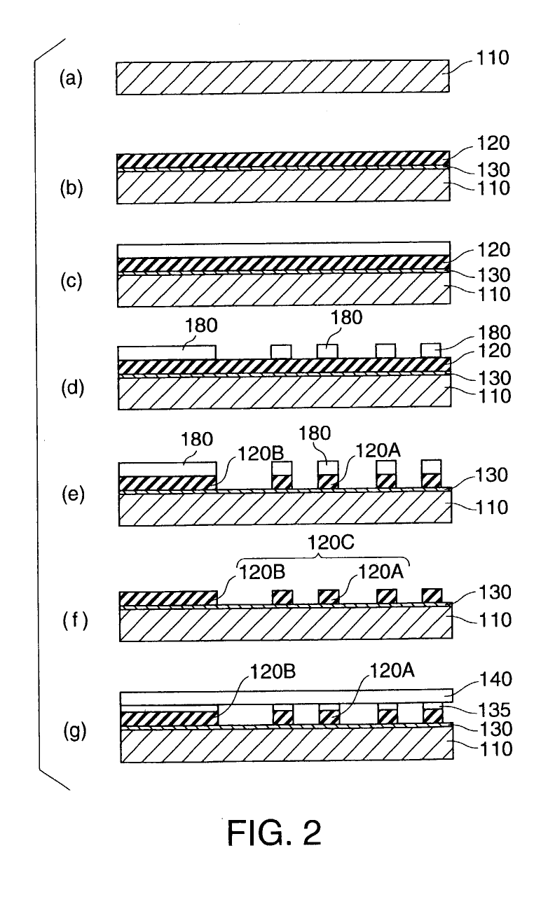

As shown in FIGS. 3(c) and 3(d), when the pressure-sensitive adhesive layer 135 or adhesive layer in the opening of the mesh formed of a thin metal film functions as a flattening layer,no problem occurs. In general,however, as shown in FIG. 2(g), the concaves and convexes in the surface of the thin metal film (foil) provides a rough surface which deteriorates transparency. Further, in some cases, the concaves and convexes in the mesh formed of the thin metal film makes it difficult to laminate the assembly onto a front panel of glass or the like, an antireflection layer, a display or the like. To overcome this drawback, preferably, before the formation of the pressure-sensitive adhesive layer or the adhesive layer, a resin is coated onto the assembly in its side of the mesh formed of the thin metal film to form a flattening resin layer 6 (see FIGS. 7 to 9).

In coating the resin, care should be taken so as not to leave air bubbles at the corner of the mesh formed of the thin metal film and not to deteriorate the transparency. Preferred coating methods for avoiding this unfavorable phenomenon include a method wherein a coating material having low viscosity using a solvent or the like is coated and the coating is then dried, and a method wherein a resin is laminated while removing air.

Formation of NIR Layer or AR Layer

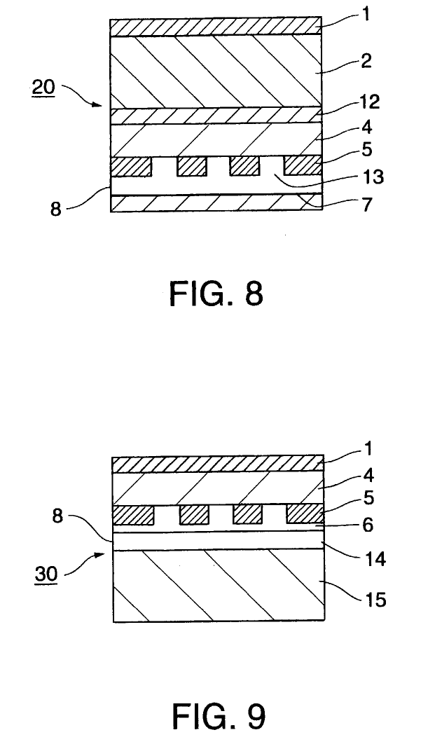

When the production process involves the step of lamination wherein, after the lamination treatment (d) wherein a silicone separator (a silicone-treated, easily separable PET film) is laminated, an NIR layer film comprising an NIR layer provided on one side of a film and an AR layer film comprising an AR layer provided on one side of a film are laminated in that order onto the surface of the transparent film substrate remote from the mesh, an electromagnetic wave shielding member (a front protective plate for displays) can be produced which, in addition to an electromagnetic wave shielding function, has a near-infrared absorption function and an antireflection function. The electromagnetic wave shielding member (front protective plate for displays) may have layer constructions as shown in FIGS. 7 and 8 in addition to this layer construction.

Embodiments of the Present Invention

Embodiments of the present invention will be described with reference to the accompanying drawings.

First Embodiment

At the outset, a first embodiment of the production process of an electromagnetic wave shielding member according to the present invention will be described with reference to FIG. 1.

This embodiment relates to a production process of an electromagnetic wave shielding member, shown in FIG. 5, for use in the preparation of an electromagnetic wave shielding plate used in such a manner that the electromagnetic wave shielding plate is placed in front of displays such as PDP. More specifically, this production process is a process for mass producing an electromagnetic wave shielding member which has electromagnetic wave shielding properties and see-through properties and comprises a transparent film substrate and, provided on one side of the substrate, a mesh formed of a thin metal film at least one surface of which has been blackened by chromate treatment, the mesh being stacked on one side of the substrate. In this case, a 1 to 100 μm-thick copper foil or an iron material (low carbon steel) is used as a metal foil for the formation of the mesh formed of a thin metal film.

At the outset, a continuous film substrate wound into a roll form is provided (S110) and is brought to a stretched state without loosening (S111), and a continuous (chromated) metal foil wound into a roll form is provided (S120) and is brought to a stretched state without loosening (S122). A continuous metal foil 120 strip is laminated (S130) onto one side of the continuous film substrate 110 strip to form a continuous laminate member 190 in a strip form wherein the film substrate 110 and the metal foil 120 have been laminated on top of each other (S140). The lamination can be carried out by means of a laminate roll comprising a pair of rolls.

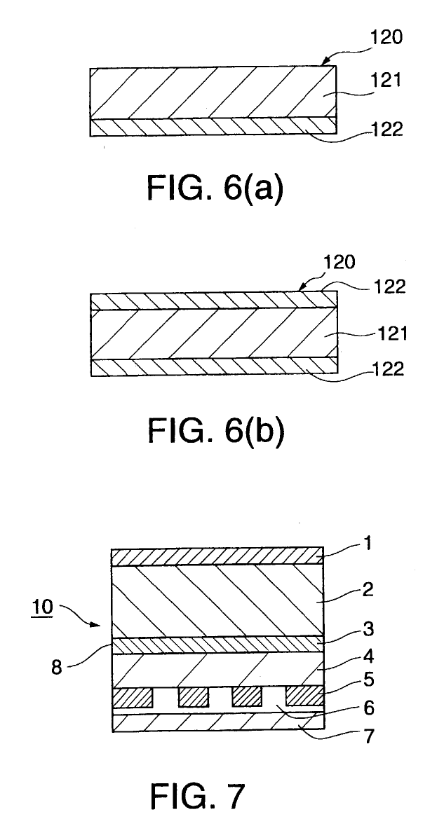

In this embodiment, the metal foil 120 is a copper foil or an iron material (a low-carbon steel substantially free from nickel), and, before lamination, blackening treatment is carried out by chromate treatment (S115 or S121) to blacken both sides of the metal foil and, consequently, to form a chromate layer 122 (see FIG. 6(b) and FIG. 1).

Here the chromation before the lamination means that a continuous metal foil generally wound into a roll is supplied (S120) and is previously chromated offline (S115).

When the continuous metal foil, which is supplied in a roll wound form (S120), is not previously chromated off line (S115), a method may be used wherein, in the step before the step of lamination, the metal foil is chromated inline (S121).

The blackening treatment was carried out by chromate treatment. In this case, a method was used wherein the metal foil 120 was dipped in an aqueous solution (25° C.) containing 3 g/liter of CrO₂ for 3 sec.

Next, masking treatment (S150) and etching treatment (S160) are carried out. In the masking treatment (S150), while carrying the laminate member 190 in a continuous or intermittent manner, in such a state that the laminate member 190 is stretched without loosening, an etching-resistant resist mask, for etching the metal foil in the laminate member to form a mesh or the like, is successively formed in a continuous or intermittent manner along the longitudinal direction of the metal foil. In the etching treatment (S160), the metal foil in its portions exposed from the resist mask is etched to form a mesh or the like formed of a thin metal film.

As shown in FIG. 3(a), etched portions 120C of a mesh or the like are provided at predetermined intervals in the metal foil in the longitudinal direction of the laminate member 190.

In this embodiment, the etched portions 120C are comprised of a mesh portion 120A and a grounding frame portion 120B as shown in FIG. 3(b). The mesh portion 120A is an electromagnetic wave shielding region.

An example of a masking treatment method comprises a series of treatments, that is, the steps of: coating a photosensitive resist, such as casein or PVA, onto a metal foil 120(S151); drying the coating (S152); then subjecting the coating to contact exposure using a predetermined pattern plate (S153); developing the exposed coating with water (S154); and performing hardening treatment and the like and baking the resist pattern (S155).

The coating of a resist is generally carried out by coating a resist, such as water-soluble casein, PVA, or gelatin, onto both sides or one side (metal foil side) of the laminate member by dipping, curtain coating, or flow coating while carrying the laminate member.

In the case of the casein resist, baking at a temperature of about 200 to 300° C. is preferred. In order to prevent the warpage or curling of the laminate member 190, however, if possible, curing is carried out at a lowest possible temperature.

When the dry film resist is a photosensitive resist, the working efficiency of the step of resist coating (S151) is good.

In the etching treatment, a ferric chloride solution is used as the etching solution. In this case, the etching solution can be easily circulated and reutilized, and the etching treatment can be easily carried out in a continuous manner.

In this embodiment, the masking treatment (S150) and the etching treatment (S160) are carried out in such a state that the laminate member 190 is stretched without loosening. The masking treatment (S150) and the etching treatment (S160) are carried out in fundamentally the same manner as used in the preparation of a shadow mask for cathode-ray tubes for color TV, from a continuous steel product strip, particularly in the etching treatment from one side of a thin sheet (20 μm to 80 μm).

That is, the masking treatment and the etching treatment can be carried out in a continuous through line, and the metal foil in a continuous laminate member strip formed of a laminate of the metal foil and the film can be continuously etched with good productivity.

After the etching treatment (S160), washing treatment and the like are carried out, a pressure-sensitive adhesive layer (corresponding to 135 in FIG. 3) serving also as a flattening layer is provided on the surface of the metal foil in a mesh form, and a silicone separator (a silicone-treated, easily separable PET film) is then laminated (S180).

The pressure-sensitive adhesive for the formation of the pressure-sensitive adhesive layer may be the same as the above-described pressure-sensitive adhesive.

The provision of the pressure-sensitive adhesive layer maybe carried out by roll coating, die coating, blade coating, screen printing or the like.

When the electromagnetic wave shielding member is used in an electromagnetic wave shielding plate, the silicone separator is separated from the pressure-sensitive adhesive layer, that is, is a temporary protective film. Thus, an electromagnetic wave shielding member having a layer construction shown in FIG. 3(c) is prepared.

Next, an NIR layer film 150 is laminated through an adhesive layer (S190), and an AR layer film 160 is then laminated onto the NIR layer film 150 through an adhesive layer (S200).

The adhesive for each of the adhesive layers may be the above adhesive. For example, highly transparent acrylic or other adhesives may be used.

For example, a pressure-sensitive adhesive (stock No. PSA-4, manufactured by Lintec Corporation) may be mentioned as a commercially available adhesive.

The antifouling layer 164 stacked onto the AR layer (163 in FIG. 3(d)) is a water-repellent, oil-repellent coating, and examples thereof include siloxane antifouling coatings and fluoro antifouling coatings such as fluorinated alkylsilyl compound antifouling coatings.

The AR layer is laminated, and, in such a state that the assembly is stretched without loosening, the assembly is cut (S210) at predetermined positions into each electromagnetic wave shielding member having a layer construction shown in FIG. 3(d) (S220).

For example, the electromagnetic wave shielding member having a layer construction shown in FIG. 3(d) thus obtained may be applied to one side of a transparent substrate, followed by the application of an AR layer film (corresponding to 160 in FIG. 3(d)) to the other side of the transparent substrate to prepare an electromagnetic wave shielding plate.

1) Variant

Instead of S180 in the above embodiment, a flattening resin layer 6 is provided on the metal mesh portion 5 in its concave/convexface. An antireflection layer or an antiglare layer may be stacked onto the flattening resin layer 6, 13 (FIGS. 7 and 8).

2) Variant

Instead of S180 in the above embodiment, a flattening resin layer 6 is provided on the metal mesh portion 5 in its concave/convex face, and an adhesive layer containing an absorber (a visible light absorber, near-infrared absorber) is stacked onto the flattening resin layer 6 (FIG. 9).

3) Variant

Prior to the laminate treatment S130 in the above embodiment, blackening treatment is not carried out on at least one side of the metal foil 120. In this variant, after the steps up to the etching treatment (S160) are carried out in the same manner as in the above embodiment, the surface portion of the metal foil 120 is blackened by chromate treatment, and, thereafter, in the same manner as in the above first embodiment, the lamination treatment for laminating a silicone separator (a silicone-treated, easily separable PET film) and steps after the lamination treatment are carried out.

4) Other Variants

A method may also be adopted wherein, before cutting (S210), the assembly is optionally wound into a roll and the treatment is temporarily stopped.

If necessary, the step of slitting the laminate member 190 into a predetermined width may be provided before the masking treatment (S190).

In the above embodiment, a copper foil is used as the metal foil. An iron material or the like may also be used as the metal foil.

After the lamination of the NIR layer film (S190), if necessary, a protective film may be applied, followed by cutting to prepare an electromagnetic wave shielding member.

Second Embodiment

Next, a second embodiment of the production process of an electromagnetic wave shielding member according to the present invention will be described with reference to FIG. 1.

In the second embodiment, instead of the laminate member formation treatment in the first embodiment, a resin is coated (S135) onto one side of a continuous metal foil strip by a coating method such as extrusion coating or hot melt coating to prepare a laminate member (S140).

The second embodiment is different from the first embodiment only in the laminate member formation treatment.

Third Embodiment

A third embodiment of the production process of an electro magnetic wave shielding member according to the present invention will be described with reference to FIG. 1.

As with the first embodiment, in this embodiment, a member for the production of an electromagnetic wave shielding plate which, in use, is placed in front of a display such as PDP shown in FIG. 5, is produced. Specifically, in this embodiment, there is provided a process for mass-producing an electromagnetic wave shielding member having electromagnetic wave shielding properties and see-through properties and comprising a transparent film substrate and a mesh formed of a thin metal film at least one surface of which has been blackened by chromate treatment, the mesh being stacked on one side of the substrate, wherein a 1 to 100 μm-thick copper foil or iron material (low-carbon steel), at least one surface of which has been blackened by chromate treatment, is used as a metal foil for the formation of the mesh formed of a thin metal film.

In this embodiment, steps up to the lamination treatment (S180) for laminating a silicone separator (a silicone-treated, easily separable PET film) are carried out in the same manner as in the first embodiment. Thereafter, the assembly is cut (S185) into each electromagnetic wave shielding member preparation region in a sheet form. An NIR layer film and an AR layer film each in a sheet form corresponding to the electromagnetic wave shielding member preparation region are successively laminated through an adhesive layer (S195, S205) to prepare an electromagnetic wave shielding member (S220).

The material for each portion and the treatment method may be the same as those in the first embodiment.

In this embodiment, a method may also be adopted wherein the cut electromagnetic wave shielding member preparation region (S185) having a layer construction corresponding to FIG. 3(c) as such may be provided as an electromagnetic wave shielding member and this electromagnetic wave shielding member, either alone or in combination with an AR layer film and an NIR layer film, is applied to a transparent substrate to prepare an electromagnetic wave shielding plate.

The cross section of a characteristic portion in each treatment (cross section at position P1-P2 in FIG. 3(b)) up to the lamination treatment (S180) in the first and third embodiments will be further briefly described with reference to FIG. 2.

FIGS. 2(a) to 2(g) are cross-sectional views taken on position P1-P2 of FIG. 3(b).

Specifically, FIGS. 2(a) to 2(g) show an embodiment wherein an adhesive is used in the laminate treatment (S130) for laminating a PET film or the like.

A metal foil 120 (FIG. 2(b)) is provided on one side of a film substrate 110 (FIG. 2(a)) through an adhesive layer 130 by the lamination treatment (S130 in FIG. 1).

A photosensitive resist is coated onto the metal foil 120, and the coating is dried(FIG. 2(c)). Thereafter,contact exposure is carried out using a predetermined pattern plate, and the exposed coating is developed and is baked to form a predetermined resist pattern 180 as shown in FIG. 2(d).

Next, the metal foil 120 is etched from one side thereof (FIG. 2(e)) using the resist pattern 180 as an etching-resistant mask. After washing treatment and the like, a pressure-sensitive adhesive layer 135 is provided on the surface of the metal foil 120, and a silicone separator 140 is laminated through the pressure-sensitive adhesive layer 135 (FIG. 2(g)).

### EXAMPLES

The following examples further illustrate the present invention.

### Example 1

In the following example, a part of a production process of an electromagnetic wave shielding member as a first embodiment shown in FIG. 1 was carried out.

In the first embodiment shown in FIG. 1, the following heat-curable adhesive A was roll coated on one side of a PET film having a thickness of 188 μm and a width of 700 mm as a film substrate (A 4300, manufactured by Toyobo Co., Ltd.), and the coating was dried to form an adhesive layer at a coverage of 4 g/m².

Heat-Curable Adhesive A

| | |
|---|---|
| Takelac A 310, manufactured by | 12 pts. wt. |
| Takeda Chemical Industries, Ltd.: | |
| Takenate A 10, manufactured by | 1 pt. wt. |
| Takeda Chemical Industries, Ltd.: | |
| Ethyl acetate: | 21 pts. wt. |

A copper foil (EXP-WS, width 700 mm, thickness 9 μm, manufactured by Furukawa Circuit Foil Co., Ltd.), wherein one side of a metal layer 121 had been blackened by chromate treatment, as shown in FIG. 6(a), was provided as a metal foil 120.

The metal foil 120 and the PET film were laminated on top of each other by means of a laminator comprising a metallic roll and a rubber roll so that the chromate layer 122 (blackening layer) of the metal foil 120 faced the adhesive layer in the PET film, with caution so as not to cause cockling or to form air bubbles. Thus, a laminate member 190 (sheet) having a total thickness of 200 μm was prepared.

A shadow mask for a cathode-ray tube for color TV was then prepared from a strip-shaped continuous steel product (thin sheet; 20 μm to 80 μm) by performing masking and etching from one side of the steel product. In this case, a process from masking to etching was carried out by a continuous through line (a shadow mask line; hereinafter referred to also as “SM line”) wherein the process from the step of masking to the step of etching was carried out in such a state that the steel product was stretched.

Casein was provided as a photosensitive resist and was flow coated so as to cover the whole one side (metal foil side) of the laminate member 190 while carrying the laminate member 190.

A pattern plate for forming a mesh portion 120A and a grounding frame portion 120B as shown in FIG. 3(b) was provided which had a mesh angle of 30 degrees, a mesh line width of 20 μm, and a mesh pitch (corresponding to Px and Py in FIG. 4) of 200 μm. This was used to carry out contact exposure with a printing frame in the SM line (S153), and the exposed coating was then developed with water (S154), was subjected to hardening treatment and the like, and was further baked at 100° C. (S155).

Next, in such a state that the laminate member 190 was stretched, a ferric chloride solution of 42 Baume degrees at 60° C. as an etching solution was sprayed on the metal foil using the resist pattern as an etching-resistant mask to etch the exposed region, whereby a mesh portion and a grounding frame portion were formed.

Next, in the SM line, in such a state that the laminate member 190 was stretched, the laminate member 190 was washed with water, the resist was separated with an alkaline solution, and, further, washing, drying and the like were carried out.

Flattening Treatment

A urethane ultraviolet-curable resin having a viscosity of 1500 mPa·s was then provided and was coated by screen printing to a thickness of 40 μm on only the concave-convex face of a metal foil (a mesh portion) so as not to cover the ground electrode portion around the film.

Further, a 38 μm-thick untreated PET film having high surface smoothness was laminated as a peel film by means of a laminator onto the screen printed face.

Thereafter, the print was cured with ultraviolet light at a dose of 200 μmJ/cm², and the 38 μm-thick untreated PET film having high surface smoothness was separated to produce a flattened metallic mesh sheet.

Formation of Color Adhesive Layer

Color Adhesive Material 1

| | |
|---|---|
| Nickel complex compound | 2 pts. wt. |
| (near-infrared absorber) | |
| Neodymium oxide | 2 pts. wt. |
| (visible light absorber) | |
| Polyester resin | 550 pts. wt. |
| Methyl ethyl ketone | 920 pts. wt. |
| Toluene | 920 pts. wt. |

The color adhesive material 1 was dispersed and mixed by means of a triple roll to prepare a color adhesive. Next, the color adhesive was coated by means of a 100-μm applicator onto the surface of the flattened layer in the flattened metallic mesh sheet. The coating was then dried at about 90° C. to remove the solvent. Thus, an electromagnetic wave shielding member was prepared which had a layer construction such that a 10 μm-thick color adhesive layer was formed.

A glass plate was stacked onto the electromagnetic wave shielding member in its color adhesive layer side.

Comparative Example 1

The procedure of Example 1 was repeated, except that the ingredients of the color adhesive material 1 used in Example 1 were changed as follows.

Color Adhesive Material 2

| | |
|---|---|
| Polyester resin | 550 pts. wt. |
| Methyl ethyl ketone | 920 pts. wt. |
| Toluene | 920 pts. wt. |

Evaluation Test

The spectral transmittance and reflectance of the electromagnetic wave shielding members produced in Example 1 and Comparative Example 1 were measured. The results were as shown in Table 1 below.

In the measurement of the spectral transmittance and reflectance, the reflectance and transmittance of visible light with wavelengths of 380 to 780 nm were measured with a spectrometer UV-3100 PC manufactured by Shimadzu Seisakusho Ltd., and the transmittance of near-infrared with a wavelength of 1000 nm was measured with an integrating sphere.

TABLE 1

| | Visible light with wave- | | | Near-infrared with |
|---|---|---|---|---|
| | lengths of 380 to 780 nm | | | wavelengths of 1000 nm |
| | Transmit- | Reflect- | | |
| | tance T, % | ance R, % | R/T | Transmittance T, % |
| Ex. 1 | 62% | 15% | 0.24 | 11% |
| Comp. | 77% | 38% | 0.49 | 92% |
| Ex. 1 | | | | |

1. An electromagnetic wave shielding member comprising:
a transparent film substrate; and a mesh formed of a thin metal film stacked on the surface of the transparent film substrate through an adhesive and/or a pressure-sensitive adhesive,
said adhesive and/or said pressure-sensitive adhesive comprising an absorber which can absorb specific wavelengths, i.e., the wavelengths of visible light and/or near-infrared.

2. The electromagnetic wave shielding member according to claim 1, which further comprises a layer, for flattening the concave/convex face of the mesh, stacked on the mesh layer formed of the thin metal film,
at least one of the adhesive and/or the pressure-sensitive adhesive and the flattening layer comprising an absorber which can absorb specific wavelengths, i.e., the wavelengths of visible light and/or near-infrared.

3. The electromagnetic wave shielding member according to claim 2, which further comprises a layer comprising an absorber, which can absorb specific wavelengths, i.e., the wavelengths of visible light and/or near-infrared, stacked on the surface of the transparent film substrate or the surface of the flattening layer.

4. The electromagnetic wave shielding member according to any one of claims 1 to 3, wherein the thin metal film is a thin film of copper.

5. The electromagnetic wave shielding member according to any one of claims 1 to 4, wherein the surface of the mesh formed of the thin metal film has been blackened.

6. The electromagnetic wave shielding member according to claim 5, wherein the blackening treatment has been made by chromate treatment.

7. An electromagnetic wave shielding member comprising: the electromagnetic wave shielding member according to any one of claims 1 to 6; and a visible light absorption layer and/or a near-infrared absorption layer stacked on the electromagnetic wave shielding member.

8. The electromagnetic wave shielding member according to claim 7, wherein an antireflection layer and/or an antiglare layer are further stacked.

9. The electromagnetic wave shielding member according to claim 7 or 8, wherein a transparent substrate is further stacked.

10. A display device comprising: a display; and the electromagnetic wave shielding member according to any one of claims 1 to 9 stacked on the surface of the display.
